(19) United States
(12) Patent Application Publication
(10) Pub. No.: US 2026/0349275 A1
(43) Pub. Date: Nov. 5, 2026

(54) LENS WITH HOLOGRAPHIC MATERIAL

(71) Applicant: TRULIFE OPTICS LIMITED, London Greater London (GB)

(72) Inventors: Ben SHERLIKER, London Greater London (GB); Kingsley Gerard HANLON, London Greater London (GB); Humberto SILVA, London Greater London (GB)

(73) Assignee: TRULIFE OPTICS LIMITED, London Greater London (GB)

(21) Appl. No.: 19/486,805

(22) PCT Filed: May 23, 2024
(86) PCT No.: PCT/EP2024/064204

§ 371 Date: Nov. 21, 2025

(30) Foreign Application Priority Data
May 24, 2023 (GB) 2307759.7

(51) Int. Cl. G02C 7/02; G02B 1/04; G02B 1/14; G02B 5/32

(52) U.S. Cl. CPC G02C 7/022; G02B 1/041; G02B 1/14; G02B 5/32

(57) ABSTRACT

A lens is disclosed, in particular and eyeglass lens for a wearable head-up display and associated method of manufacturing the lens. The lens comprises a plastic lens body having a plurality of optical surfaces; a lens coating layer arranged on at least one of the optical surfaces; a substrate layer, arranged over the lens coating layer; and a holographic emulsion layer, arranged on the substrate layer, wherein the lens coating layer, substrate layer and holographic emulsion layer are arranged as a transparent layer stack on the lens body. There is also disclosed a wearable head-up display comprising such an eyeglass lens.

### CROSS-REFERENCE TO RELATED APPLICATIONS

This application is a national stage application, filed under 35 U.S.C. § 371, of International Patent Application No. PCT/EP2024/064204, filed on May 23, 2024, which claims priority to United Kingdom Patent Application No. 2307759.7, filed on May 24, 2023, the entire contents of each of which is incorporated by reference herein in its entirety.

### FIELD OF THE DISCLOSURE

The present disclosure relates to a lens, in particular an eyeglass lens and a method of manufacturing such an eyeglass lens. More particularly, the disclosure relates to an eyeglass lens for a wearable head-up display. The disclosure also relates to a wearable head-up display, comprising such an eyeglass lens.

### BACKGROUND OF THE DISCLOSURE

In the field of augmented reality (AR), an optical element is a material which, when exposed to light, refracts, diffracts, attenuates, or otherwise modifies the properties of the light. A diffractive element is an optical element that is comprised of a series of ridges or fringes that form an optical element by diffracting light. Non-limiting examples of diffractive elements include a hologram, a holographic optical element, a volume diffraction grating, a surface relief diffraction grating, a transmission grating, or a reflection grating.

Diffractive elements are generally fabricated using light-reactive substances, which when exposed to light under the correct conditions form a series of very small and carefully spaced fringes that function as a diffractive optical element. Non-exclusive examples of light reactive substances for forming diffractive optical elements are silver-halide emulsions or photopolymers as disclosed in US20190025596A1. It is well known that such diffractive elements optical elements are typically integrated with eyeglass lenses for wearable head-up display and/or AR applications.

However, integrating photopolymers into eyeglass lenses for wearable head up displays is difficult due to the need to incorporate the photopolymer film into the moulding process or lamination of the photopolymer film on to a curved surface, unless the photopolymer is coated onto a lens having a cylindrically shaped surface, that is flat in one direction and curved in the other. As mentioned above, an alternative approach to photopolymers is to use silver halide emulsions. However, a known problem with such silver halide emulsions is that they are prone to delamination from the lens material and in particular where the lens comprises curved surfaces such as convex or concave curved outer lens surfaces and the lens is made from plastic polymer materials such as for example polycarbonate (PC), CR39® or Trivex®. For example the gelatine in some silver halide emulsions doesn't bond to glass as it is organic to inorganic which doesn't chemically bond.

### SUMMARY OF THE DISCLOSURE

According to an aspect of the disclosure there is provided an eyeglass lens for a wearable head-up display, comprising a plastic lens body having a plurality of optical surfaces; a lens coating layer arranged on at least one of the optical surfaces; a substrate layer, arranged over the lens coating layer; and a holographic emulsion layer, arranged on the substrate layer, wherein the lens coating layer, substrate layer and holographic emulsion layer are arranged as a transparent layer stack on the lens body.

The holographic emulsion layer is suitable for forming a holographic optical element (HOE) therein. The lens coating layer may be metal or metalloid oxide material and may be one of, or a combination of, a SiO₂, TiO₂, SnO₂, SbO₂, ZrO₂ based material.

Optionally, the lens coating layer may be an organosilicon based layer and the organosilicon layer may be a silane, a siloxane or a polysiloxane based material. The lens coating layer may comprise a mixture of the organosilicon based layer and one of or a combination of the SiO₂, TiO₂, SnO₂, SbO₂, ZrO₂ based material.

The substrate layer is a pre-subbing layer and the pre-subbing layer is a combination of a gelatine based material, a silane-based material, and a hardener, and wherein the hardener is glutaraldehyde. The silane-based material may be 3-aminopropyltriethoxysilane.

The holographic emulsion layer is a silver halide based material and the halide may be one of chlorine, bromine or iodine. The silver halide-based material may consist of crystals of silver halide dispersed in a gelatine material.

The plastic lens may be selected from one of CR-39, Trivex®, 1.6 resin or Polycarbonate. There is also provided a wearable head-up display comprising the eyeglass lens according to the disclosure.

According to another aspect of the disclosure there is provided a method of manufacturing an eyeglass lens for a wearable head-up display, the method comprising the steps of: on a plastic lens body having a plurality of optical surfaces, depositing a lens coating layer on at least one of the optical surfaces; depositing a substrate layer on the lens coating layer, and depositing a emulsion layer on the substrate layer, wherein the lens coating layer, substrate layer and holographic emulsion layer are arranged as a transparent layer stack on the lens body.

Prior to depositing the substrate layer, the lens coating layer is may optionally be cleaned in a solution of sodium hydroxide (NaOH). Each of the lens coating layer, substrate layer or emulsion layer may be applied by one of vacuum evaporation, dip coating or spin coating, curtain coating or spray coating.

### BRIEF DESCRIPTION OF THE DRAWINGS

So that the manner in which the features of the present disclosure can be understood in detail, a more particular description is made with reference to embodiments, some of which are illustrated in the appended figures. It is to be noted, however, that the appended figures illustrate only typical embodiments and are therefore not to be considered limiting of its scope. The figures are for facilitating an understanding of the disclosure and thus are not necessarily drawn to scale. Any hatching or shading is shown solely for the purposes of aiding clarity. Advantages of the subject matter claimed will become apparent to those skilled in the art upon reading this description in conjunction with the accompanying figures, in which like reference numerals have been used to designate like elements, and in which:

FIG. 1 illustrates a schematic view of an eyeglass lens layer stack according to embodiments;

FIG. 2 illustrates an exploded schematic view of an eyeglass lens layer stack according to embodiments;

FIG. 3 illustrates a flow diagram of the method steps of forming an eyeglass lens layer stack according to embodiments;

FIG. 4 illustrates a schematic view of an encapsulated eyeglass lens layer stack according to embodiments;

FIG. 5 illustrates an exploded schematic view of an encapsulated eyeglass lens layer stack with encapsulated layers according to embodiments;

FIG. 6 illustrates a flow diagram of the method steps of forming a holographic optical element in an eyeglass lens layer stack according to embodiments; and

FIG. 7 illustrates a wearable head-up display comprising an eyeglass lens layer stack according to embodiments.

### DETAILED DESCRIPTION

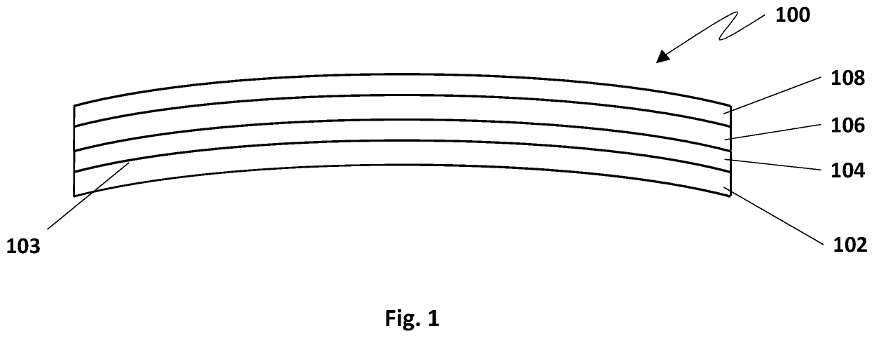

In overview, FIG. 1 illustrates an eyeglass lens 100 suitable for a wearable head-up display. The eyeglass lens 100 comprises a lens body 102. A lens coating material 104 is formed on a major optical surface 103 of the lens. The skilled person will appreciate that the lens coating material 104 may be arranged on a convex major surface 103 of the lens body 102 (as illustrated) or alternatively on a concave major surface of the lens body 102. In the context of the present embodiment the concave major surface may be considered as “eye-facing”, whereas the convex major surface may be considered as “world-facing”. By way of example, the lens body 102 may have a meniscus shaped profile, meaning that the eye-facing surface is concave, and the world facing surface is convex. Alternatively, the lens body 102 may be for example biconvex, plano-convex, convex-concave, plano-concave or biconcave in profile.

A substrate layer 106 is formed on the lens coating material 104 and a holographic emulsion layer 108 is formed on the substrate layer 106. The lens body 102, the lens coating layer 104, the substrate layer 106 and the holographic emulsion layer 108 are arranged as a layer stack forming the eyeglass lens 100 according to embodiments. The lens coating layer 104, substrate layer 106 and holographic emulsion layer 108 are optically transparent. Such coatings are commonly used for scratch-resistant coatings on lenses, including eyeglasses, camera lenses, and other optical instruments.

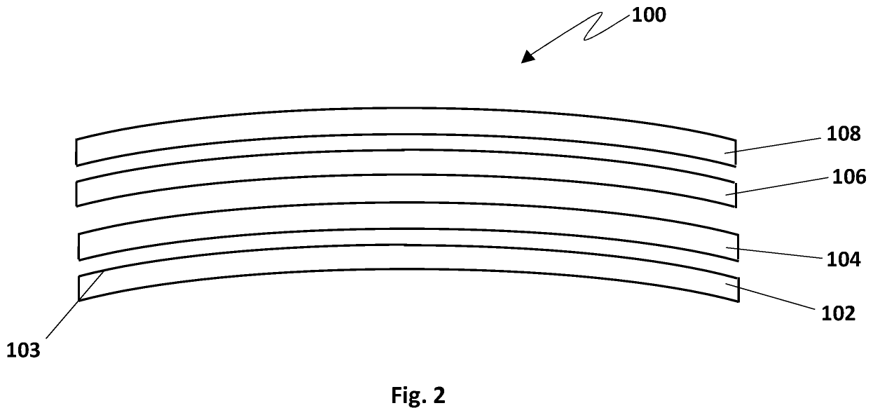

FIG. 2 illustrates an exploded view of each of the layers of the eyeglass lens 100 of FIG. 1 forming the layer stack. The lens body 102 is formed of any suitable ophthalmic quality organic lens material such as for example CR-39®, MR7® Trivex®, SuperFin®, 1.6 resin (or higher refractive index) or polycarbonate (PC). Organic plastic lens materials are preferred over glass materials due to their low weight and high optical transparency. The lens body 102 may be “finished”, that is the final user prescription may be formed on the lens body 102. In this regard, the radii of curvature of the “world-facing” and “eye-facing” surfaces of the lens body 102 may be finished such that the lens has the desired optical power for a specific user's ophthalmic prescription. The “world-facing” and “eye-facing” lens body 102 surfaces may also be termed as the front and rear surfaces respectively. The lens body 102 may be any suitable ophthalmic lens such as a corrective lens to improve vision from common refractive error disorders such as myopia, hypermetropia, astigmatism, and presbyopia. Alternatively, the lens body 102 may be a so-called Plano lens or zero power lens such as those used in zero prescription sunglasses, or zero prescription glasses worn as a fashion accessory.

The lens body 102 illustrated has a spherical radius of curvature on both the front and rear surfaces, however other curvatures and profiles are contemplated based on the above-mentioned lens profiles. Simple spherical lenses are often used for zero power stock lenses, for applications including sunglasses, ski goggles and fashion glasses. In such applications, both the front and back surfaces have spherical curvature where the two curvature profiles are concentric. For prescription lenses, cylindrical power is often added to the rear lens surface to correct for astigmatism. However, the surface is normally spherocylindrical (as described in “Principles of Ophthalmic Lenses”, M Jalie, Association of British Dispensing Opticians College of Education).

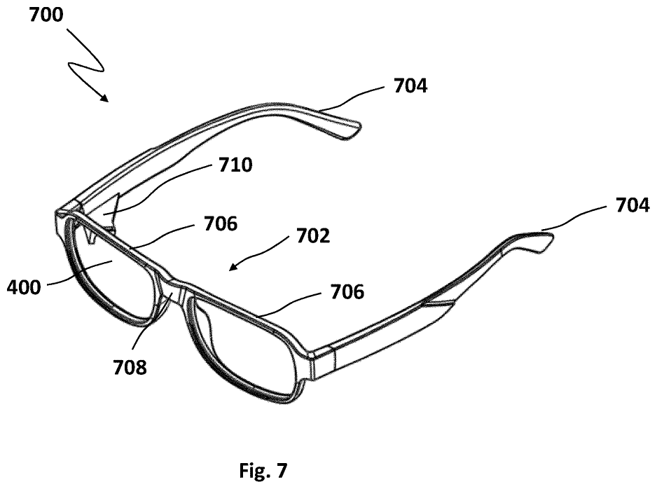

Typically, the front and rear surfaces are spherically curved or may be preferably spherical or spherocylindrical but could alternatively be toric or aspheric. In this way the lens body 102 can be considered as pre-formed, prior to formation of the eyeglass lens 100 layer stack. Alternatively, the lens body 102 may be “semi-finished”. In other words, one or more major surfaces of the lens body 102 may be ground or milled from a lens blank or puck to impart the relevant ophthalmic prescription following formation of the eyeglass lens 100 layer stack. In the situation where the layer stack is formed on the front surface the of the lens body 102, the rear surface may be milled, ground or polished from a standard ophthalmic lens blank base curvature (typically defined in Diopters and ranging from zero to 10) to impart the desired prescription. In this way it is possible to create a stock of eyeglass lenses 100 according to embodiments that can later be adapted to a specific user prescription for incorporation in wearable head-up display of the type illustrated in FIG. 7. The lens body 102 may be manufactured by grinding, injection moulding techniques, 3D printing techniques or any suitable combination thereof.

Organic plastic lenses of the types described above provide good candidates for eyewear applications due to their low weight and height optical transparency. However, such lenses are considered to be mechanically soft (at least when compared to glass lenses) and thus highly susceptible to mechanical damage such a scratching. To increase the scratch resistance of the lens body 102 material the lens coating layer 104 may be applied to the surface of the lens 102. For example, the lens coating material may be an inorganic oxide such as a metal oxide, metalloid oxide or ceramic. Examples of inorganic oxide-based material can include SiO₂, TiO₂, SnO₂, SbO₂, ZrO₂, or combinations thereof, applied to one or more of the optical surfaces of the lens 102. Alternatively, the lens coating material 104 may be an organosilicon such as silane or siloxane. For example, the organosilicon material may be applied in liquid form to the lens 102 by for example dip coating, spin coating or spray coating and then cured to form a hard coating on one or more surfaces of the lens. The organosilicon material may be a polysiloxane based material. Optionally, the lens coating material 104 may comprise a mixture of polysiloxane based material and inorganic materials as mentioned above. The lens coating material may be a thermally and/or light (typically UV) curable material.

The lens coating may comprise silicon oxide nanoparticles embedded in a polysiloxane polymer matrix, or an acrylic and polysiloxane polymer matrix. Alternatively, the lens coating may comprise tin, titanium and antimony oxide nanoparticles embedded in a polyurethane and polysiloxane polymer matrix. Alternatively, the lens coating may comprise titanium and zirconium oxide nano particles embedded in a polysiloxane polymer matrix.

The lens coating layer 104 may also be applied to the optical surfaces of the lens 102 by a vacuum evaporation technique such as quartzing or a vapour deposition technique such as physical vapour deposition (PVD), sputter deposition or electron beam PVD. Alternatively, the lens coating layers may be applied by dip coating, spray coating and thermal and/or UV-curing or other appropriate coating technique mentioned below.

Following application of the lens coating layer 104, the substrate layer 106 may be applied on the lens coating material 104. This substrate layer 106 is applied to the lens coating material 104 to improve the adhesion of the later applied organic holographic emulsion layer 108 thereto. As discussed in more detail below, the holographic emulsion layer 108 may be a silver halide and gelatine based material.

The substrate layer 106 is also known as a “pre-coating” or “pre-subbing” in art of holographic emulsions. The terms “pre-coating” or “pre-subbing” refer to the application of a layer of material onto the surface of a substrate before the application of the holographic emulsion, with the purpose of improving the adhesion and reducing defects in the holographic emulsion layer 108. The terms “pre-subbing” and “pre-coating” are often used interchangeably in the field of holographic emulsion technology, and they refer to the same process of applying a layer onto the surface of a substrate before the application of the holographic emulsion layer 108.

The substrate layer 106 may be a silane based compound which bonds to the lens coating material and allows the holographic emulsion layer 108 to bond to the substrate layer 106. The substrate layer may also include dilute gelatine and optionally a hardener such as glutaraldehyde or ammonium/potassium dichromate. The silane-based compound may be 3-aminopropyltriethoxysilane. The substrate layer 106 allows for the bonding of organic material based holographic emulsion layers, to layers containing inorganic materials such as silicon dioxide (glass), silane or titanium dioxide or polysiloxane based materials as mentioned above. The substrate layer is an intermediate layer which can bond to both organic and inorganic materials and hence acts as a bridging bond. With certain organic plastics the substrate layer provides good adhesion with an organic layer of the holographic emulsion layer.

As understood by the skilled person, the thickness of the lens may be any appropriate thickness dependent on the required optical power and refractive index of the lens material. The thickness of the lens coating layer 104 may be in the region of several μm. The thickness of the substrate layer 106 may be in the range of tens of nm up to hundreds of nm. The thickness of the holographic emulsion layer 108 is between 1 μm and 20 μm, but preferably between 4 μm to 12 μm. If the thickness is less than 3 μm it is difficult to form a volume hologram suitable for AR applications.

The combination of the lens coating layer 104 and substrate layer 106 allows for uniform coating of the holographic emulsion layer 108 on plastic lenses 102, via the lens coating layer 104 and substrate layer 106, such that the holographic emulsion layer 102 does not deform or delaminate. Tests have shown that without the coating layer 104 and the substrate layer 106, the holographic emulsion layer 108 delaminates from plastic lenses.

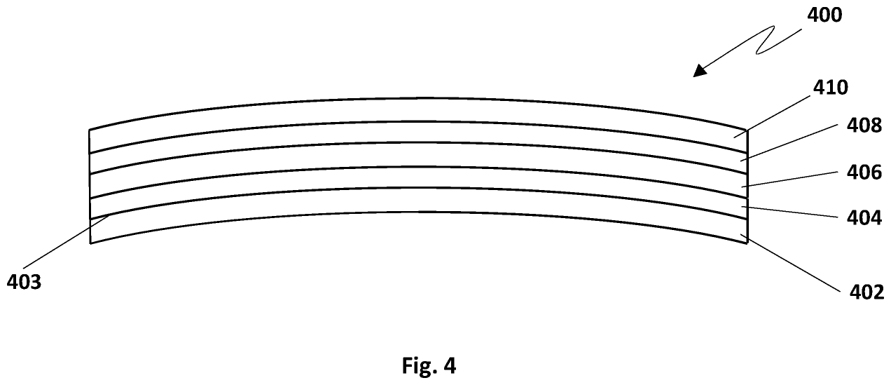

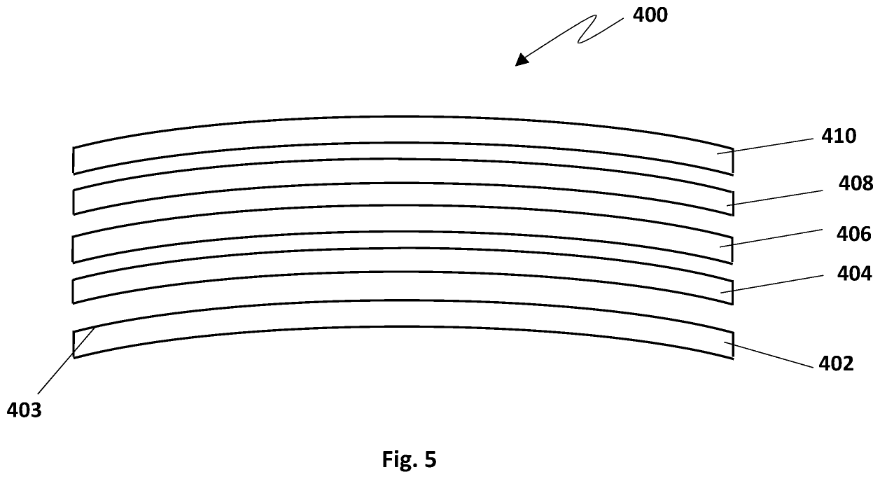

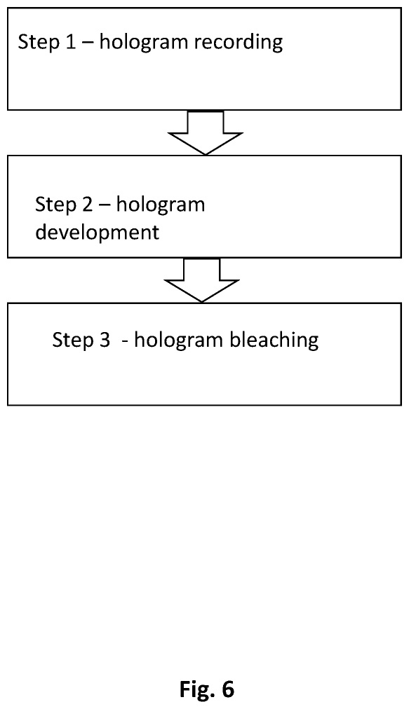

The holographic emulsion layer 108 (and 408 discussed below with reference to FIGS. 4 and 5) may be any suitable material that is sensitive to light. For example, the holographic emulsion layer 108 may be a silver halide-based material. Silver halide is a salt of silver and a halide, where the halide may be selected from any one of or any appropriate combination of chlorine, bromine and/or iodine. The silver halide material comprises crystals of silver halide dispersed in a gelatine material as is well known in the art. The skilled person will recognise that there are many possibilities for the preparation of silver halide based holographic emulsions examples of which are disclosed in EP0737887B1, the contents of which are incorporated herein by reference. A holographic optical element (HOE) may be formed in the holographic emulsion layer 108 by local variation of the refractive index in the material as discussed below with reference to the method steps of FIG. 6. It should be noted that FIG. 1 and corresponding FIG. 2 are not drawn to scale and are merely indicative of the arrangement of the various body 102 layers of the eyeglass lens.

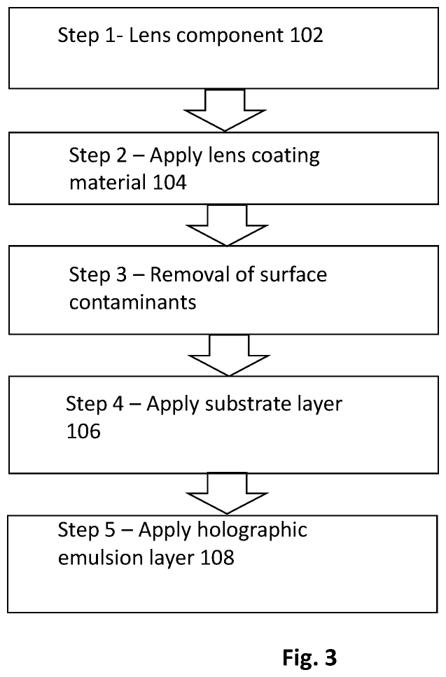

With reference to FIG. 3, the method steps of forming the eyeglass lens 100 layer stack according to embodiments is described. The method begins at Step 1, where the lens body 102 is provided. The lens body 102 may be a finished lens, that is the final user prescription may be formed in the lens and the lens may be shaped for inclusion in a suitable frame such as an AR glasses frame for example of the type as shown in FIG. 7. Alternatively, the lens body 102 may be an unfinished lens blank, or puck and the final user prescription may be imparted on the lens at a later stage by grinding or milling a surface of the lens that is uncoated by the Steps 2 to 4 as discussed below. Optionally, prior to Step 2 as discussed below the uncoated lens body 102 may be cleaned to remove any contaminants. This cleaning step may optionally use a 5 to 20% sodium hydroxide (NaOH) aqueous solution at 50 °C optionally with ultrasonication for 3 to 15 minutes, followed by rinsing with deionized water. The use of sodium hydroxide may optionally provide a roughening of the lens body 102 surface which may improve adhesion of the applied lens coating layer 104 thereto.

The method continues at Step 2 where the lens coating layer 104 is applied to at least one of the optical surfaces of the lens (eye-facing side and/or world facing side) of the lens body 102. This lens coating layer 104 may be of the types mentioned above and described for example in U.S. Pat. No. 3,476,827, the contents of which are incorporated herein by reference. Alternatively, the lens coating layer 104 may be applied to the lens body 102 by any appropriate method, as discussed above and examples of which are mentioned in US2021/0317336, the contents of which are incorporated by reference. The lens coating layer 104 provides protection from damage, such as scratching, of the lens body 102 during subsequent processing steps. The lens coating layer 104 also acts as a coupling layer allowing the substrate layer 106 to more easily adhere, be attached or be formed on (compared to a lens body 102 without lens coating layer 104) to the optical surface of the lens body 102. The lens coatings can vary in their composition, but they typically consist of for example around 60-70% metalloid or metal oxide material by weight. Such metalloid or metal oxide-based materials, such as colloidal silica (as a nanocomposite), may be applied by vacuum deposition or by techniques such as dip coating or spin coating in a polysiloxane based varnish, followed by a polymerisation process such as baking at approximately 100 °C or by exposure to UV radiation. The exact percentage of metal or metalloid oxide materials in the lens coating material can vary depending on the manufacturing process used and the specific requirements of the application. The lens coating material 104 may also be an organosilicon such as silane or siloxane. For example, the organosilicon material applied as a varnish to the lens 102 by dip coating or spin coating and then cured to form a hard coating on one or more surfaces of the lens. The organosilicon material may be a polysiloxane based material.

Following formation of the lens coating layer 104, the method continues at Step 3, where the coated lens is optionally initially washed to remove any surface contaminates. The lens body 102 having the lens coating layer 104 applied is then immersed in a solution of sodium hydroxide. As mentioned above, the lens coating layer 104 may exhibit properties similar to those of glass (containing silicon-based materials such as inorganic silicon dioxide, or silane), therefore as well as removing surface contaminants the lens wash Step 3 may also provide a key to allow the following application of the substrate layer 106 to adhere to the surface of the lens coating layer 104.

Following immersion in sodium hydroxide at Step 3, the substrate layer 106 is then applied to the lens coating layer 104 at Step 4. As mentioned, the substrate layer 106 also known as a “pre-subbing” layer can prevent defects such as air bubbles and/or wrinkles from forming in the final holographic emulsion layer that could possibly cause delamination of the later applied holographic emulsion layer 108 from the lens 100. The substrate layer 106 may typically be composed of a polymer or other material that forms a smooth, even surface that is well suited for the application of the holographic emulsion layer 108. The substrate layer 106 may also provide additional benefits such as improved barrier properties, reduced processing times, and/or increased stability of the emulsion layer 108.

The substrate layer 106 may be applied to the lens coating material 104 by any appropriate method. For example, the substrate layer 106 material can be applied as a solution on the lens coating layer 106 material by for example immersion, after which it is allowed to dry. Following drying, a 1% weight per volume solution in acetone of 3-amino-propyltriethoxysilane is applied to the dried substrate layer and acetone is allowed to evaporate. This is then allowed to stand to ensure the reaction of the silane, in a process called salinization, and then rinsed with methanol. Alternative methods of applying the substrate layer 106 may include dip coating, spin coating, spray coating or curtain coating. The skilled person will appreciate that any suitable coating method, as described above may be used to apply the substrate layer 106 to the curved surface of the lens coating 104. The substrate layer 106 acts as a foundation layer for the holographic emulsion layer 108 and without wishing to be bound by theory the inventors believe that because the substrate layer 106 is a silane based compound this causes a chemical attraction to the metal oxide or the organosilicon based lens coating material 104.

Following application of the substrate layer 106 at Step 4, the holographic emulsion layer 108, as described above, is applied at Step 5. Similarly to the application of the lens coating and the substrate layer, the holographic emulsion layer 108 may be applied by any appropriate method known to those skilled in the art, such as for example dip coating, spin coating, spray coating or curtain coating.

Based on the current disclosure, the skilled person will appreciate that in the context of eyeglass lenses for head-up display applications the holographic emulsion layer is an emulsion layer in which it is possible to record a holographic fringe structure (or HOE) as discussed in more detail below with reference to FIG. 6.

FIG. 4 illustrates a schematic view of a further embodiment of the eyeglass lens 100 discussed above. It should be noted that FIG. 4 and corresponding FIG. 5 are not drawn to scale and are merely indicative of the arrangement of the various stack layers of the eyeglass lens according to embodiments. The eyeglass lens 400 of FIG. 4 comprises a first lens body 402. A lens coating material 404 is formed on a major surface 403 of the lens. A substrate layer 406 is formed on the lens coating material 404 and a holographic emulsion layer 408 is formed on the substrate layer 406. Compared to the arrangement of FIG. 1, the eyeglass lens 400 additionally comprises a second lens body 410 arranged on the holographic emulsion layer 408. The first lens body 402, the lens coating layer 404, the substrate layer 406, the holographic emulsion layer 408 and the second lens body 410 are arranged as a layer stack forming the eyeglass lens 400 according to embodiments. In this way the holographic emulsion layer 408 is sandwiched or encapsulated between two lens bodies 402, 410 which acts to protect the holographic emulsion layer 408. The skilled person will also appreciate that the holographic emulsion layer 408 may alternatively or additionally be formed on the second lens body 410 in the same way that it is formed on the first lens body 402.

The skilled person will appreciate that the lens coating material 404 may be arranged on a convex major surface 403 of the first lens body 402 (as illustrated) or alternatively on a concave major surface of the second lens body 410. In either case, the stack of lens coating material 404, substrate layer 406 and a photographic emulsion layer 408 is thus sandwiched between the first and second lens bodies 402, 410. In the context of the present embodiment a concave major surface of the lens bodies 402, 410 may be considered as “eye-facing”, whereas the convex major surfaces the first and second lens bodies 402, 410 may be considered as “world-facing”. By way of example, the lens bodies 402, 410 may have a meniscus shaped profile, meaning that the eye-facing surface is concave, and the world facing surface is convex. Alternatively, the lens bodies 402, 410 may be for example biconvex, plano-convex, convex-concave, plano-concave or biconcave in profile.

FIG. 5 illustrates an exploded schematic view of the eyeglass lens layer stack according to FIG. 4. Compared to the arrangement of FIG. 2, the eyeglass lens 400 additionally comprises a second lens body 410 arranged on the holographic emulsion layer 408. In addition, and whilst not illustrated, the second lens body 410 may comprise a lens coating material followed by a substrate layer 406 on the side of the second lens body 410 adjacent to the holographic emulsion layer 408. In the example of FIGS. 5 and 6, this would be on the eye facing side (concave) of the second lens body 410.

With reference to FIG. 6, the process steps of forming the hologram (that is the holographic optical element or HOE) in the eyeglass lens stack 100, 400 are described in general terms. There are several known techniques process and materials used for forming the hologram as discussed for example in Practical Holography, Graham Saxby, 3^{rd} Edition, IOP Publishing Ltd, 2004, Chapter 5 and Appendix 5, the contents of which are incorporated herein by reference. At Step 1 the holographic emulsion layer 108, 408 is exposed to two interfering beams of coherent light (in reflection or transmission geometry), such as generated from a single mode laser at a power of approximately 1 mW/cm² for several seconds to form the latent image of the holographic optical element in the holographic emulsion layer 108, 408 by local variation of the refractive index of the holographic emulsion to form a holographic fringe structure. The latent image of the holographic optical element is then developed at Step 2 and bleached at Step 3, discussed for example in Saxby, referenced above. Steps 2 and 3 are wet processes. The latent image of the holographic optical element is developed to an amplitude hologram using a suitable developer comprising a developing agent and an alkali. The bleaching step uses a re-halogenating bleach to change the amplitude hologram to a phase hologram, improving the transparency and efficiency of the holographic optical element. As an alternative to re-halogenating bleach, solvent bleaches may also be used. The lens is then allowed to dry and may then be encapsulated as discussed with regard to FIGS. 4 and 5.

FIG. 7 illustrates an augmented reality system comprising at least one of the eyeglass lenses described above. This augmented reality system takes the form of a wearable heads-up display, such as for example, a pair of glasses 700. As with known types of glasses, the glasses 700 according to an embodiment include a frame 702. The frame includes arms 704, and lens mounting portions 706 connected by a bridge portion 708. One of the arms 704 includes a mounting portion 710 in which an image source is fixedly mounted to, such that a light beam from the image source (not illustrated in FIG. 7) will be incident on the eyeglass lens stack 100, 400 as described above. The skilled person will appreciate that the image source will be mounted on the arm 704 adjacent the lens mounting portion 706 holding the eyeglass lens stack 100, 400 according to embodiments. The other lens mounting portion may have a standard ophthalmic lens inserted therein. Alternatively, an eyeglass lens stack 100, 400 according to embodiments may be mounted in the other lens mounting portion and there may be an additional projector system mounted on a corresponding mounting portion on the other arm 704.

One or both of the arms 704 may also be adapted to house a battery (not illustrated) to power the projector as discussed above. In addition, one or both of the arms 704 may also include control electronics (not illustrated) for controlling the operation of the image source. The image source may be a MEMS based projector system or a pixelated projection system such as LOCOS, microLED or OLED based system. In addition, the operation of the projector may be controlled via the control electronics or by an eye tracking system (not illustrated). The eye tracking system may include a non-visible light source, such as an infra-red LED, directed to the user's eye and a photo sensor arranged to capture the non-visible light reflected by the user eye. Embodiments as described herein apply equally to waveguide or free-space based AR systems.

Particular and preferred aspects of the disclosure are set out in the accompanying independent claims. Combinations of features from the dependent and/or independent claims may be combined as appropriate and not merely as set out in the claims.

The scope of the present disclosure includes any novel feature or combination of features disclosed therein either explicitly or implicitly or any generalisation thereof irrespective of whether or not it relates to the claimed disclosure or mitigate against any or all of the problems addressed by the present disclosure. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

Features which are described in the context of separate embodiments may also be provided in combination in a single embodiment. Conversely, various features which are, for brevity, described in the context of a single embodiment, may also be provided separately or in any suitable sub combination.

1. An eyeglass lens for a wearable head-up display, comprising a plastic lens body having a plurality of optical surfaces; a lens coating layer arranged on at least one of the optical surfaces; a substrate layer, arranged over the lens coating layer; and a holographic emulsion layer, arranged on the substrate layer,
wherein the lens coating layer, substrate layer and holographic emulsion layer are arranged as a transparent layer stack on the lens body.

2. The eyeglass lens of claim 1 and wherein the holographic emulsion layer is suitable for forming a holographic optical element (HOE) therein.

3. The eyeglass lens of claim 1, wherein the lens coating layer is a metal or metalloid oxide material.

4. The eyeglass lens of claim 3, wherein the lens coating layer is one of, or a combination of, a SiO₂, TiO₂, SnO₂, SbO₂, ZrO₂ based material.

5. The eyeglass lens of claim 1, wherein the lens coating layer may be an organosilicon based layer and the organosilicon layer may be a silane, a siloxane or a polysiloxane based material.

6. The eyeglass lens of claim 4, wherein the lens coating layer may be an organosilicon based laver and the organosilicon laver may be a silane, a siloxane or a polysiloxane based material, and wherein the lens coating layer may comprise a mixture of the organosilicon based layer and one of or a combination of the SiO₂, TiO₂, SnO₂, SbO₂, ZrO₂ based material.

7. The eyeglass lens of claims 1, wherein the substrate layer is a pre-subbing layer.

8. The eyeglass lens of claim 7, wherein the pre-subbing layer is a combination of a gelatine based material, a silane-based material, and a hardener, and wherein the hardener is glutaraldehyde.

9. The eyeglass lens of claim 8, wherein the silane-based material is 3-aminopropyltriethoxysilane.

10. The eyeglass lens of claim 1, wherein the holographic emulsion layer is a silver halide based material and the halide is one of chlorine, bromine or iodine.

11. The eyeglass lens of claim 10, wherein the silver halide-based material consists of crystals of silver halide dispersed in a gelatine material.

12. The eyeglass lens of claim 1, wherein the plastic lens is selected from one of CR-39, Trivex®, 1.6 resin or Polycarbonate.

13. A wearable head-up display comprising the eyeglass lens of claim 1.

14. A method of manufacturing an eyeglass lens for a wearable head-up display, the method comprising the steps of: on a plastic lens body having a plurality of optical surfaces, depositing a lens coating layer on at least one of the optical surfaces; depositing a substrate layer on the lens coating layer, and depositing a emulsion layer on the substrate layer, wherein the lens coating layer, substrate layer and holographic emulsion layer are arranged as a transparent layer stack on the lens body.

15. The method of manufacturing the eyeglass lens according to claim 14, wherein prior to depositing the substrate layer, the lens coating layer is cleaned in a solution of sodium hydroxide (NaOH).

16. The method of manufacturing the eyeglass lens of claim 15, wherein each of the lens coating layer, substrate layer or emulsion layer may be applied by one of vacuum evaporation, dip coating or spin coating, curtain coating or spray coating.

17. The method of manufacturing the eyeglass lens of claim 14, wherein a holographic optical element is formed in the holographic emulsion layer.
